(19) United States
(12) Patent Application Publication
(10) Pub. No.: US 2025/0164654 A1
(43) Pub. Date: May 22, 2025

(54) Radiation window

(71) Applicant: Oxford Instruments Technologies Oy, Espoo (FI)

(72) Inventor: Seppo Nenonen, Espoo (FI)

(21) Appl. No.: 18/840,516

(22) PCT Filed: Feb. 21, 2023
(86) PCT No.: PCT/FI2023/050101

§ 371 Date: Aug. 22, 2024

Related U.S. Application Data
(60) Provisional application No. 63/312,408, filed on Feb. 22, 2022.

(51) Int. Cl. G01T 7/00

(52) U.S. Cl. CPC G01T 7/00

(57) ABSTRACT

According to an example aspect of the present invention, there is provided an X-ray window construct comprising a structural frame comprising an aperture, covering the aperture and affixed to the structural frame, a window layer comprising two-dimensional polymer material which consists of monomers covalently joined to form two-dimensional sheets.

### FIELD

The present invention relates to window structures that are at least partially transparent to radiation, such as x-rays.

### BACKGROUND

Radiation measurement devices operate by determining a reaction of a detector device to incoming radiation. For example, an x-ray camera may receive x-rays and determine their intensity as a function of location on a two-dimensional charge-coupled device, CCD, array. A spectrometer, on the other hand, may be configured to determine spectral characteristics of incoming radiation, for example to determine an astrophysical redshift or to identify characteristic emission peaks of elements to analyse elemental composition of a sample.

When measuring soft x-rays, by which it may be meant, for example, x-rays with energy below 1 keV, providing the radiation to a detector presents with challenges. For example, air scatters soft x-rays and many materials absorb soft x-rays, wherefore the radiation most conveniently is conveyed to a detector through vacuum, wherein the detector may be placed in the vacuum.

When operating in atmospheric circumstances, a suitable window may be arranged to admit soft x-rays into the vacuum where a detector may be arranged to analyse the radiation. Such a window would ideally be transparent to the soft x-rays and durable of construction

Transparency may be increased by reducing the thickness of the window. For example, beryllium windows have been used, wherein the thinner the window is, the larger a fraction of incoming radiation is admitted through the window. On the other hand, the thinner the window is, the likelier it is to break in real-life circumstances.

To increase durability of a window, the window may be supported with a mechanical grid or it may be sandwiched between supporting structures. Supporting structures may take the form of web-like support structures, which partially cover and partially expose the window material. In parts where the window material is exposed by supporting structures, the window is maximally transparent to incoming radiation.

### SUMMARY OF THE INVENTION

The invention is defined by the features of the independent claims. Some specific embodiments are defined in the dependent claims.

According to a first aspect of the present invention, there is provided an X-ray window construct, comprising a structural frame comprising an aperture, and a window layer, covering the aperture and affixed to the structural frame, the window layer comprising two-dimensional polymer material which consists of monomers covalently joined to form two-dimensional sheets

According to a second aspect of the present invention, there is provided a method comprising obtaining a first silicon wafer comprising a mask on a first side, attaching a second silicon wafer on the first side of the first silicon wafer, and etching one of the wafers to partially expose a window layer deposited on the opposite silicon wafer and to leave a structure defined by the mask supporting the window layer, the window layer comprising two-dimensional polymer material which consists of monomers covalently joined to form two-dimensional sheets.

According to a third aspect of the present invention, there is provided a method comprising obtaining a first silicon wafer comprising a silicon oxide layer thereon, the silicon oxide layer comprising a recess, attaching a second silicon wafer on the first silicon wafer, the second silicon wafer having a window layer deposited thereon, the window layer thereby being inserted into the recess, and etching through the first silicon wafer to expose the window layer, and etching through the second silicon wafer in accordance with a mask, to construct a support structure for the window layer, the window layer comprising two-dimensional polymer material which consists of monomers covalently joined to form two-dimensional sheets.

### BRIEF DESCRIPTION OF THE DRAWINGS

FIG. 1 illustrates an example system capable of being operated with at least some embodiments of the present invention;

FIG. 2A-FIG. 2E illustrate an example manufacturing process in accordance with at least some embodiments of the present invention;

FIG. 3A-FIG. 3E illustrate a variant of the process of FIGS. 2A-2E, and

FIG. 4A-FIG. 4E illustrate an example manufacturing process in accordance with at least some embodiments of the present invention.

### EMBODIMENTS

X-ray radiation window constructs where a radiation window layer comprises two-dimensional polymer material are disclosed herein. Such a material provides several technical advantages in an X-ray window, such as transparency to soft X-rays with an energy less than 1 keV, long-term stability in an X-ray radiation environment and resilience to impacts of particulate matter, allowing maintenance of a vacuum, or at least low-pressure environment, on one side of the window layer. Two-dimensional polymers also enable building thin yet rigid window layers which are well suited to integration in compact structures.

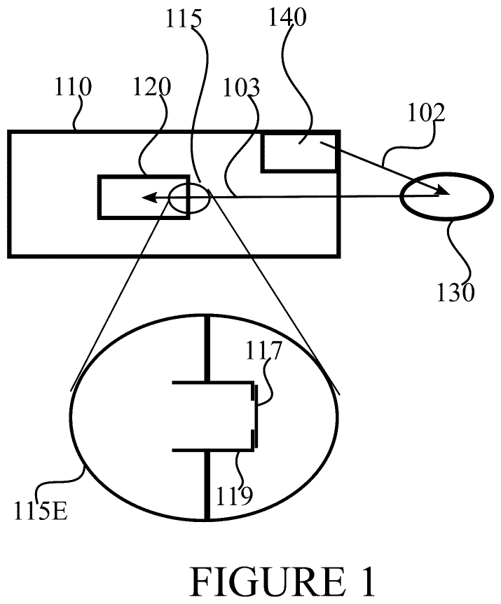

FIG. 1 illustrates an example system capable of being operated with at least some embodiments of the present invention. The illustrated system relates to x-ray fluorescence, to which the present invention is not limited, rather, windows constructs built in accordance with the present invention may find application also more broadly.

FIG. 1 illustrates an analytic device 110, which comprises an x-ray detector 120. X-ray detector 120 is in this example configured to determine spectral characteristics of x-rays incident on itself, for example to enable elemental composition analysis based on characteristic emissions.

In use, the arrangement of FIG. 1 irradiates sample 130 with primary x-rays 102 from primary x-ray source 140, stimulating matter comprised in sample 130 to emit, via fluorescence, secondary x-ray radiation 103, spectral characteristics of which are determined, at least partly, in x-ray detector 120.

X-ray detector 120 comprises a window region 115, which is arranged to admit x-rays into X-ray detector 120. Window region 115 is illustrated in an enlarged view 115E at the bottom of FIG. 1, wherein a gap in the outer housing of X-ray detector 120 is shown. Arranged in the gap is an opening wherein an X-ray window construct comprising structural frame 119 is disposed. Structural frame 119 which comprises an aperture for admitting X-rays, as illustrated. Window layer 117 covers the aperture and is affixed to structural frame 119, preventing inflow of air from outside X-ray detector 120 to inside X-ray detector 120 while allowing x-rays, such as, for example, soft x-rays, to enter X-ray detector 120, so that these x-rays may be analysed in x-ray detector 120. Window layer 117 comprises two-dimensional polymer material which consists of monomers covalently joined to form two-dimensional sheets. Window layer 117 may be at least 50%, at least 60% or at least 70% comprised of the two-dimensional, 2D, polymer material. An example of the 2D polymer material is 2D polyaramide, but other 2D polymers may also be used alternatively to, or in addition to, the 2D polyaramide. A 2D polymer may be considered as an in-plane covalently bonded material.

By being comprised by at least a specific percentage of the 2D polymer, it is meant that in the window material, at least this specific percentage of monomers are in covalently bonded 2D structures, sheets, rather than in covalently bonded one-dimensional filaments, or loose. As described above, 2D polymers, such as 2D polyaramide, are well suited to X-ray window layers since they are transparent to soft X-rays and resistant to X-rays and particulate impacts. The transparency to X-rays follows from the fact polymers are comprised of light elements Carbon, Oxygen, Nitrogen and Hydrogen. 2D polymers are further capable of withstanding and maintaining a pressure differential, rendering them suited to act as a window layer 117 which may endure use for several years. The monomer in 2D polymers may comprise melamine, as in the case of 2D polyaramide, for example. Melamine contains a ring of carbon and nitrogen atoms. The two-dimensional sheets formed by the 2D polymer may be predominantly of a thickness of a single monomer. In case the monomer is melamine, as in the case of 2D polyaramide, this thickness may be about 3.67+/−0.28 Ångströms, for example.

A window layer may be between 25 and 300 nanometres, or between 50 and 300 nanometres, thick, for example. The thickness of window layer 117 may be selected based on the intended application, and/or based on the intended presence or absence of a supporting structure to support window layer 117. For example, a range of 50-500 nanometres is well suitable for energy-dispersive X-ray spectroscopy, involving scanning electron microscopy, SEM, and transmission electron microscopy, TEM. On the other hand, a thickness range of 0.5 to 5 micrometres is well suited for X-ray fluorescence, XRF applications. This is so, since XRF is typically performed in an air, or Helium, atmosphere wherefore the atmospheric gas absorbs soft, <1 keV X-rays and a thicker window layer without a support structure is acceptable. In SEM and TEM the X-ray detector is in vacuum, wherefore a thinner window layer, potentially with a support structure, is preferable. In case no supporting structure is used, window layer 117 may be made thicker to give it more rigidity. The thickness of the window layer, when using the spinning method, may be controlled by selecting suitably a concentration of trifluoroacetic acid, TFA, solution used and/or by spinning speed. The plural 2D nanosheets ideally are predominantly aligned with a single plane defined by a surface of the window layer. The window layer may comprise plural 2D sheets which are smaller in area than window layer 117, the sheets being sandwiched between each other to form a rigid, solid structure. When observing the window layer at high magnification, its surface may resemble a surface formed of nanosheets like platelets aligned in a planar manner on top of each other, forming a tight, bound structure. The sheets are held together by hydrogen bonds between the layers of sheets, which make the structure dependably stable. In the case of 2D polyaramide, its elastic modulus, which is a measure of how much force it takes to deform a material, is approximately five times greater than that of bulletproof glass, while 2D polyaramide has only about one-sixth the density of steel.

In some embodiments, a visible-light blocking layer is provided upon window layer 117. This visible-light blocking layer, where present, may be of Aluminium, for example. An Aluminium visible-light blocking layer may be between 20 and 100 nanometres thick, for example. Plural 2D sheets of the 2D polymer are thus overlaid on each other to form window layer 117.

Overall, an X-ray analytic device comprising an X-ray window construct, a housing and an X-ray sensor may be provided. The X-ray analytic device may comprise an XRF, SEM or TEM device, for example, or a part for such a device.

A process whereby 2D polymer layers may be manufactured is disclosed in the publication “Irreversible synthesis of an ultrastrong two-dimensional polymeric material”, by Yuwen Zeng et al., Nature vol 602, 3 Feb. 2022. The manufacturing method (“Methods”, “Synthesis”) is incorporated herein by reference to enable the skilled person to manufacture window layer 117 of the two-dimensional polymer material.

In detail, 2D polyaramide may be synthesized as follows: a 40-ml vial equipped with a stir bar is added with 126 mg of melamine (1 mmol, 1 equiv.), and 265 mg of trimesic acid trichloride (1 mmol, 1 equiv.), followed by 9 ml of N-methyl-2-pyrrolidone and 1 ml of pyridine. The mixture is stirred at room temperature (20-25° C.).

After 16 h, the whole reaction mixture becomes a gel. This gel is cut into small pieces and then soaked in ethyl alcohol (80 ml), followed by 30-min bath sonication if necessary. The resulting cloudy mixture is further filtrated or centrifuged, followed by deionized H2O (80 ml) and acetone (80 ml) washing. A pale-yellow powder (228 mg, 81%) is received after house-vacuum drying at 100° C. for 16 h.

Silylated 2D polyaramide may be synthesized for analysis as follows: 10 mg of 2D polyaramide is added into a 4-ml glass vial, followed by 2 ml of CHCl3, excess amount of trimethylsilyl trifluoromethanesulfonate (0.3 ml) and triethylamine (0.5 ml). The mixture is stirred at room temperature until a black homogenous solution is formed. Owing to the unstable nature of trimethylsilyl, TMS, protected compounds, this reaction solution is diluted without any purification and directly deposited onto mica for possible subsequent atomic force microscopy, AFM, characterization.

After synthesis, to measure acyl residue fraction, the reaction mixture may be quenched with 40 ml of isopropyl alcohol. The resulting slurry may be stirred for at least 3 h and then purified to give the isopropyl-terminated 2D polyaramide. Dissolving the product in trifluoroacetic acid, TFA, allows 1H nuclear magnetic resonance, NMR, offering the desired acyl residue-to-monomer ratio.

Films, nanofilms, may be produced of 2D polyaramide by dissolving 2D polyaramide powder in TFA, forming a homogenous solution. The 2D polyaramide solution can then be added to the top of a clean SiO2-covered Si wafer. Instead of a substrate, a microwell could also be used. Then this wafer can be spun at 2000 rpm for 1 min, giving a uniform nanofilm. Its thickness can be measured by AFM at scratches made by a fine needle. Such a film may be used as window layer 117. The spinning process results in a window layer affixed to the Si wafer. [Alternatively, or additionally, the window layer may be affixed to the structural frame by being sandwiched in parts between layers of the structural frame. The window layer may also be transferred to other substrates after manufacturing it. Such transferring may comprise using an etching solution of HF/HNO2/DIW at ratios HF 10, HNO3 2 and DIW 100. The substrate may be places in a plastic container, e.g. petri dish, and the etching solution may be added to cover the substrate and window layer. The window layer will be detached from the substrate in about 24 hours.

In some embodiments, the X-ray window construct may be disposed in the housing of analytic device 110, rather than at X-ray detector 120. A supporting structure may take a form and shape that is suitable for supporting window layer 117 thereon, to withstand atmospheric pressure, for example, in case the inside of x-ray detector 120 is maintained at low pressure, or, indeed, vacuum or near-vacuum. For example, supporting structure 119 may comprise a square or rectangular layout, or a spider-web shape, to provide support for window layer 117 while not obscuring too much of window layer 117.

A X-ray window construct, comprising a structural frame 119, which comprises the aperture which window layer 117 covers, may be manufactured as a separate unit for inclusion in a variety of different devices which are designed to admit X-rays, in particular soft X-rays, into a housing. The aperture admits the X-rays, while the window layer prevents contamination and matter flows into the housing.

In general, a supporting structure, attached to window layer 117, may partially obscure and partially expose window layer 117. In detail, a part of window layer 117 touching support structure will be obscured by it, by which it is meant that x-rays passing through window layer 117 will at these places be partially prevented, by the support structure, from reaching x-ray detector 120. In parts of window layer 117 not touching the support structure, x-rays that penetrate window layer 117 may proceed directly to x-ray detector 120. The larger the part of window layer 117 touching, and obscured by, the supporting structure, the stronger is the support provided to window layer 117 and the larger the effect the supporting structure has on x-rays incoming through window layer 117. The strength of the supporting structure may thus be seen as a trade-off between transmittance through window layer 117 and strength of the radiation window structure which comprises window layer 117 and the supporting structure. In general, window layer 117 may be completely exposed on a first side and partly exposed on a second side, the supporting structure being on the second side. By completely exposed, or continuously exposed, it is meant window layer 117 is exposed in a manner that an area of window layer 117 in active use is not obstructed by a support structure on the continuously exposed side. In case window layer 117 is sufficiently thick, it may be unnecessary to furnish it with a supporting structure.

Window layer 117 may be continuous in nature, by which it is meant the layer is not interrupted, for example, in accordance with the support structure. A continuous window layer may be planar in the sense that it lies in a single plane.

Window layer 117 may be thin, in the nanometer range, while extending over an opening which is in the order of a few millimetres, or centimetres, in size, for example.

Window layer 117 may have, for example on a side not facing a support structure, at least one supplementary layer. Examples of supplementary layers include a thin aluminium layer and a graphene layer. An aluminium layer may block, at least partly, visible light from entering through window layer 117. When one side of window layer 117 is clear from supporting structures, such supplementary layers may be applied easier and the resulting layers have fewer defects. This provides the beneficial technical effect that the layers function better in their respective purposes. Supplementary layers may alternatively be referred to as surface layers.

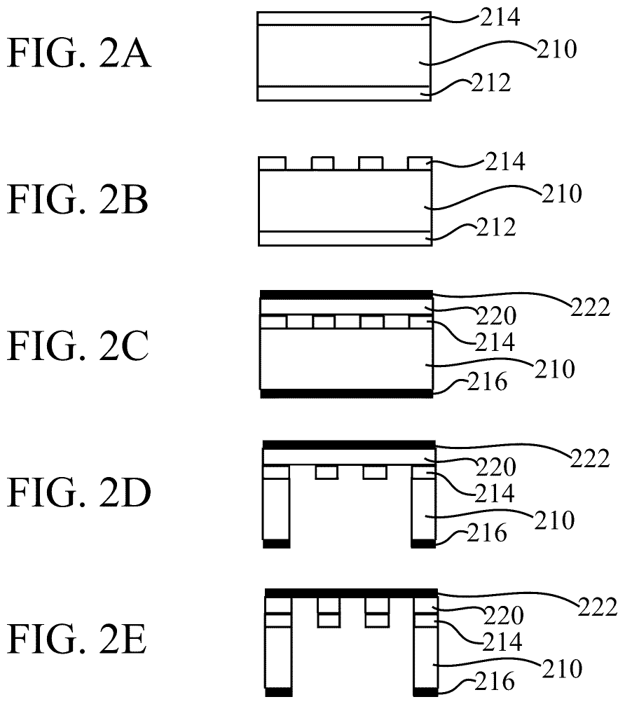

FIG. 2A-FIG. 2E illustrate an example manufacturing process in accordance with at least some embodiments of the present invention. The process begins at the situation of FIG. 2A, where a silicon wafer 210 is obtained, comprising at least a first silicon oxide layer 214, and, optionally, a second silicon oxide layer 212.

As the process advances to the situation illustrated in FIG. 2B, first silicon oxide layer 214 has been patterned, by removing part thereof, to leave behind a mask that defines a shape of a supporting structure. The pattern need not penetrate all the way through first silicon oxide layer 214. In some embodiments, the silicon wafer is also patterned before oxidation, to generate deeper structures.

As the process advances to the situation illustrated in FIG. 2C, a second silicon wafer 220 has been attached on top of the mask layer 214. Second silicon wafer 220 thereon a window layer 222, which comprises a 2D polymer material. Window layer 222 may be placed on second silicon layer 220 using the spun method described herein above. An optional silicon nitride layer 216 may be deposited on the opposite side of first silicon wafer 210. Where present, second silicon oxide layer 212 may be removed to arrive at the situation illustrated in FIG. 2C.

As a variant of this process, alternatively second silicon wafer 220 may be provided with an oxide layer, which is patterned to form the mask. Then first silicon wafer 210 may be attached onto second silicon wafer 220 to cover the mask. Subsequently, first silicon wafer 210 may be etched, as described below. An advantage of providing the mask on second silicon wafer 220 is that attaching errors will have no effect on etching.

As the process advances to the situation illustrated in FIG. 2D, first silicon wafer 210 has been etched to expose mask 214 and, partially, second silicon wafer 220, masked by mask 214.

As the process advances to the situation illustrated in FIG. 2E, etching is continued to partially expose window layer 222 from the side of first silicon wafer 210. In the process, a supporting structure is constructed of second silicon wafer 220, which supports window layer 222. Optionally, in a subsequent stage, the exposed silicon oxide from mask 214 may be removed.

Overall, therefore, in the process of FIGS. 2A-2E, the first silicon wafer 210 is provided with mask 214, the second silicon wafer 220 is attached to the first silicon wafer 210 on the first side, leaving mask 214 between these wafers, and then the first silicon wafer 210 and the second silicon wafer 220 are etched from the second side, different from the first side, to partially expose window layer 222. The supporting structure is thereby formed of second silicon wafer 220, on the second side of window layer 222.

As a modification of the process described above, a sacrificial etch stop layer, for example 1 micrometer of PECVD SiO2 or a multilayer structure, may be provided between second silicon wafer 220 and window layer 222, to protect window layer 222, which may be delicate, during chemical and/or mechanical stress during silicon etching phases of the process.

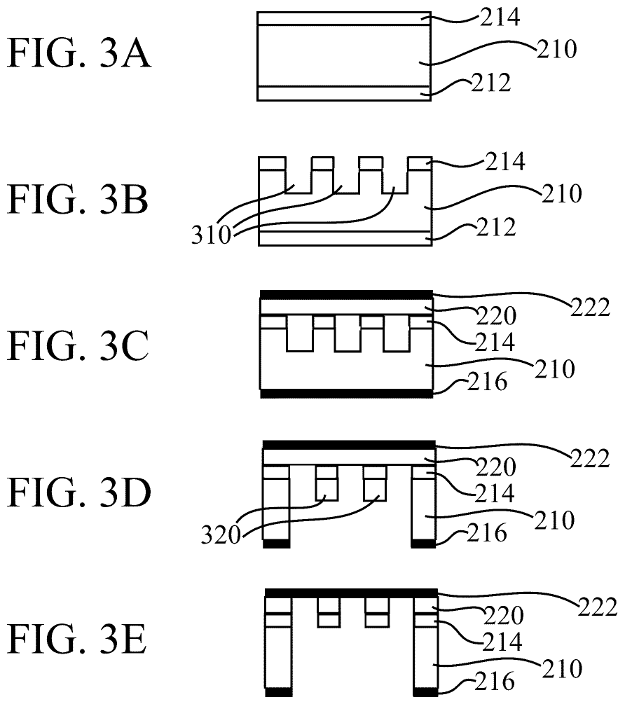

FIG. 3A-FIG. 3E illustrate a variant of the process of FIGS. 2A-2E. Like numbering denotes similar structure. FIG. 3A corresponds to FIG. 2A.

FIG. 3B corresponds to the situation of FIG. 2B, with the exception that first silicon wafer 210 is partly etched, using mask 214, to facilitate the subsequent etching from the other side. The resulting recesses are denoted in FIG. 3B with reference sign 310. As in advancing to the situation illustrated in FIG. 2C, in advancing to the situation illustrated in FIG. 3C a second silicon wafer 220 has been attached on top of the mask layer 214. Second silicon wafer 220 has deposited thereon a window layer 222, which comprises the 2D polymer material, as disclosed herein above. An optional silicon nitride layer 216 may be deposited on the opposite side of first silicon wafer 210. Where present, second silicon oxide layer 212 may be removed to arrive at the situation illustrated in FIG. 2C.

In the phase of FIG. 3D, a quantity of silicon from first silicon wafer 210 remains, covering parts of mask 214. This is due to the recesses 310 created earlier. The remaining silicon is denoted in FIG. 3D with reference sign 320. This silicon may be removed in subsequent phases of the process.

Overall, therefore, in the process of FIGS. 3A-3E, the first silicon wafer 210 is etched from a first side, the second silicon wafer 220 is attached to the first silicon wafer 210 on the first side, leaving mask 214 between these wafers, and then the first silicon wafer 210 and the second silicon wafer 220 are etched from the second side, different from the first side, to partially expose window layer 222. A supporting structure is thereby formed of second silicon wafer 220, on the second side of window layer 222.

As a further modification of the process of FIGS. 2A-2E or FIGS. 3A-3E, a second supporting structure may be constructed on the other side of window layer 222. While the second supporting structure may make deposition of a further layer on window layer 222 more difficult, having a supporting structure on both sides of window layer 222 results in superior rigidity for the resulting window structure. Such a structure may be constructed as described above in connection with FIGS. 2A-2E or FIGS. 3A-3E, wherein further a third silicon wafer is attached to the other side of window layer 222, the third silicon wafer provided with a silicon oxide layer on top which is patterned to produce a second mask, and subsequently etching to produce the second supporting structure using the second mask and to partially expose window layer 222 also from the top side. The other supporting structure may be produced as described above in connection with FIGS. 2A-2E or FIGS. 3A-3E.

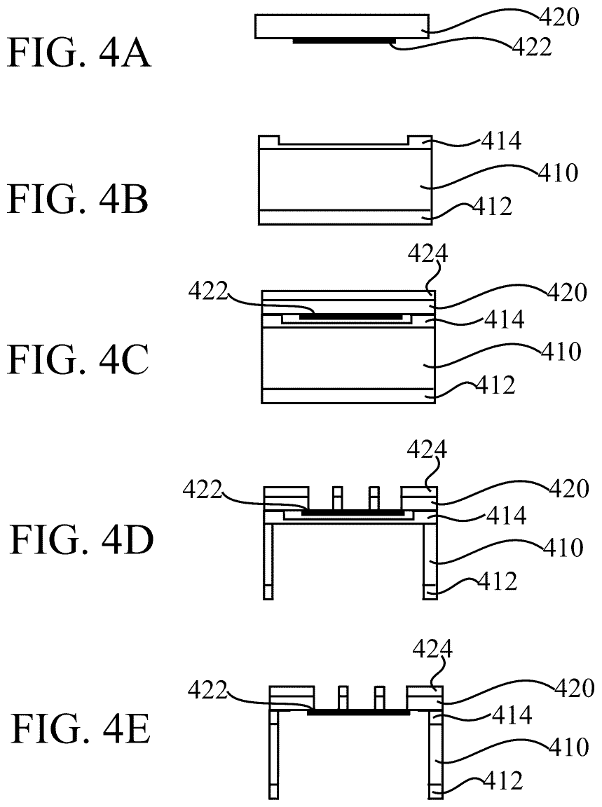

FIG. 4A-FIG. 4E illustrate an example manufacturing process in accordance with at least some embodiments of the present invention. In FIGS. 4A and 4B, a first silicon wafer 410 is furnished with first silicon oxide layer 414 and, optionally, second silicon oxide layer 412. First silicon oxide layer is worked to obtain therein a recess. Second silicon wafer 420 has deposited thereon a window layer 422, which comprises the 2D polymer material, as discussed herein above. The window layer 422 may be spun on second silicon wafer 420, for example, as disclosed above.

Moving to the situation of FIG. 4C, second silicon wafer 420 has been attached to first silicon wafer 410. In connection with this attaching, window layer 422 is inserted in the recess of first silicon oxide layer 414. A gap may be left between window layer 422 and the bottom of the recess. Further, a top silicon oxide layer 424 is obtained on top of second silicon wafer 420.

Moving to the situation of FIG. 4D, the top silicon oxide layer 423 is patterned to impart thereon a shape of a support structure, the remaining part of top silicon oxide layer 423 forming a mask. Etching is performed from the top side, to construct on window layer 422 a supporting structure, the shape of which is defined by mask 424. In the process, window layer 422 is partially exposed from the top side, wherein the non-exposed part of window layer 422 is in contact with the support structure. Furthermore, etching is performed from the bottom side to expose first silicon oxide layer 414.

Finally, to obtain the result illustrated in FIG. 4E, first silicon oxide layer 414 is removed to expose window layer 422 from below. As a result, window layer 422 is continuously exposed on the bottom side and supported by the supporting structure on the top side, facilitating application of at least one layer on window layer 422 from the bottom side. Examples of suitable layers include aluminium and graphene, as explained above.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in measurement devices, such as soft x-ray measurement devices, for example.

### Acronyms List

CCD charge-coupled device

REFERENCE SIGNS LIST

| | |
|---|---|
| 110 | Analytic device |
| 120 | X-ray detector |
| 115 | Window region |
| 115E | Window region, enlarged view |
| 117 | Window layer |
| 119 | Structural frame |
| 130 | Sample |
| 140 | Primary x-ray source |
| 102, 103 | Primary x-rays, secondary x-rays |
| 210 | First silicon wafer |
| 212 | Second silicon oxide layer |
| 214 | First silicon oxide layer |
| 220 | Second silicon wafer |
| 222 | Window layer |
| 216 | Silicon nitride layer |
| 310 | Cavities |
| 320 | Remaining silicon |
| 410 | First silicon wafer |
| 420 | Second silicon wafer |
| 422 | Window layer |
| 412 | Second silicon oxide layer |
| 414 | First silicon oxide layer |
| 424 | Top silicon oxide layer |

1. An X-ray window construct comprising:
a structural frame comprising an aperture; and
covering the aperture and affixed to the structural frame, a window layer comprising two-dimensional polymer material which consists of monomers covalently joined to form two-dimensional sheets.

2. The X-ray window construct according to claim 1, wherein at least 50% of the window layer is two-dimensional polymer material.

3. The X-ray window construct according to claim 1, wherein at least 60% of the window layer is two-dimensional polymer material.

4. The X-ray window construct according to claim 1, wherein at least 70% of the window layer is two-dimensional polymer material.

5. The X-ray window construct according to claim 1, wherein the two-dimensional polymer material is two-dimensional polyaramid.

6. The X-ray window construct according to claim 1, wherein the window layer is between 25 and 300 nanometres thick.

7. The X-ray window construct according to claim 1, wherein the window layer is between 50 and 300 nanometres thick.

8. The X-ray window construct according to claim 1, wherein the window layer has thereon a layer which blocks visible light.

9. The X-ray window construct according to claim 8, wherein the layer which blocks visible light is an Aluminium layer.

10. (canceled)

11. A method comprising:
obtaining a first silicon wafer comprising a mask on a first side;
attaching a second silicon wafer on the first side of the first silicon wafer, and
etching one of the wafers to partially expose a window layer deposited on the opposite silicon wafer and to leave a structure defined by the mask supporting the window layer, the window layer comprising two-dimensional polymer material which consists of monomers covalently joined to form two-dimensional sheets.

12. The method according to claim 11, wherein the window layer is deposited on a non attached side of one of the silicon wafers.

13. The method according to claim 11, wherein the structure is formed of silicon of one of the silicon wafers.

14. The method according to claim 11, wherein the method further comprises removing the mask, at least partly.

15. The method according to claim 11, wherein the method further comprises depositing at least one surface layer on a side of the window layer that does not face the structure.

16. The method according to claim 15, wherein the at least one surface layer comprises an aluminium layer.

17. The method according to claim 15, wherein the at least one surface layer comprises a graphene layer.

18. The method according to claim 11, wherein before attaching the second silicon wafer, part of the silicon of the first silicon wafer is etched from the first side in accordance with the mask.

19. The method according to claim 11, wherein an etch stop layer is provided between the window layer and the second silicon wafer.

20. (canceled)

21. (canceled)

22. A method comprising:
obtaining a first silicon wafer comprising a silicon oxide layer thereon, the silicon oxide layer comprising a recess;
attaching a second silicon wafer on the first silicon wafer, the second silicon wafer having a window layer deposited thereon, the window layer thereby being inserted into the recess, and
etching through the first silicon wafer to expose the window layer, and etching through the second silicon wafer in accordance with a mask, to construct a support structure for the window layer, the window layer comprising two-dimensional polymer material which consists of monomers covalently joined to form two-dimensional sheets.

23.-26. (canceled)
